(19) United States
(12) Patent Application Publication
(10) Pub. No.: US 2026/0316834 A1
(43) Pub. Date: Oct. 15, 2026

(54) Bottleneck Assistance System for a Vehicle, and Method for Operating a Bottleneck Assistance System

(71) Applicant: Bayerische Motoren Werke Aktiengesellschaft, Muenchen (DE)

(72) Inventor: Hubert SCHOLZ, Muenchen (DE)

(21) Appl. No.: 19/105,478

(22) PCT Filed: Jul. 5, 2023
(86) PCT No.: PCT/EP2023/068612

§ 371 Date: Feb. 21, 2025

(30) Foreign Application Priority Data
Aug. 23, 2022 (DE) 10 2022 121 311.0

(51) Int. Cl. B62D 15/02

(52) U.S. Cl. CPC B62D 15/0295

(57) ABSTRACT

A bottleneck assistance system for a vehicle includes a computing device. The computing device configure to receive surroundings data from a surroundings sensor of the vehicle, which surroundings data comprises at least image data and describe the surroundings of the vehicle. The computing device is also configured to detect a bottleneck in the surroundings data. The bottleneck is described by at least one obstacle in the surroundings, which is located at least in some areas within a predetermined distance to a driving tub of the vehicle. The computing device is also configured to display the image data together with the driving tube projected in the image data via a display device. In addition a partial projection of the vehicle at a future position is displayed via the display device, and the partial projection comprises at least one component group of the vehicle.

### BACKGROUND AND SUMMARY

The present invention relates to a bottleneck assistance system for a vehicle. In addition, the present invention relates to a method for operating a bottleneck assistance system.

Modern motor vehicles typically have parking aids. In the simplest case, such parking aids assist a driver of a vehicle when maneuvering the vehicle by means of distance notifications. In addition, camera-based systems also exist. The driver of the vehicle can thus be assisted, for example, when driving in reverse during a parking maneuver.

A driving tube of the vehicle, thus the area traveled in future by the vehicle, can also typically be visualized by means of a reversing camera. The driving tube or its boundaries are typically projected here in a camera image of the reversing camera so that the impression results that the roadway surface itself has been marked or painted. Therefore, reference is also made in this context to an augmented reality. The driver of the vehicle thus receives a view to the rear with the additional information of a future movement direction of the vehicle on the basis of a steering angle. Such systems can in principle also be used when driving forward. In particular in bottlenecks, the driver can thus be assisted when maneuvering the vehicle.

Document DE 10 2008 057 670 A1 relates to a method for assisting a vehicle driver of a vehicle, in particular when driving in reverse, in which an area behind the vehicle is displayed on a display unit, wherein a first guidance line and a second guidance line corresponding to a vehicle width are displayed overlapping the area behind the vehicle as a driving tube as a function of a present steering angle, wherein horizontal distance lines having a highlight indicating a vehicle center are output on the display unit in the driving tube at regular intervals.

Published application DE 10 2013 213 216 A1 relates to a method for assisting a driver of a vehicle in a bottleneck. The method comprises a step of inputting, a step of evaluating, and a step of providing. In the step of inputting, a piece of information about a corridor that can be traveled in the bottleneck, a piece of information about a current trajectory of the vehicle in the bottleneck, and a piece of information about a steering torque presently applied by the driver to a steering system of the vehicle are input. In the step of evaluating, the pieces of information about the corridor, the trajectory, and the steering torque are evaluated using known dimensions of the vehicle in order to identify an expected infringement of the corridor by at least a part of the vehicle. In the step of providing, a control signal is provided for a counter torque which counteracts the steering torque if the infringement is identified in order to assist the driver to avoid the infringement.

Document DE 10 2011 119 883 A1 relates to a method and a device for folding in and folding out exterior vehicle mirrors of a motor vehicle, wherein the exterior vehicle mirrors are movable independently of one another from a folded-out functional position into a folded-in protected position in each case. According to the invention, a positioning request is generated depending on the need for folding in exclusively the front passenger-side exterior vehicle mirror by means of a traffic sign identification unit if a traffic sign has been identified, which limits the permissible width of vehicles to values below a permissible maximum width and if the width of the motor vehicle having folded-out exterior vehicle mirrors is greater than the permissible maximum width.

It is the object of the present invention to disclose a solution for how a bottleneck assistance system for a vehicle can be improved.

This object is achieved according to the invention by a bottleneck assistance system and by a method for operating a bottleneck assistance system having the features according to the independent claims. Advantageous refinements of the present invention are specified in the dependent claims.

A bottleneck assistance system according to the invention for a vehicle, which is configured to receive surroundings data from a surroundings sensor of the vehicle by means of a computing unit wherein the surroundings data comprise at least image data and describe the surroundings of the vehicle. The bottleneck assistance system is furthermore configured to detect a bottleneck in the surroundings data by means of the computing unit, wherein the bottleneck is described by at least one obstacle in the surroundings, which is located at least in some areas within a predetermined distance to a driving tube of the vehicle. In addition, the bottleneck assistance system is configured to display the image data together with the driving tube projected in the image data by means of a display device. Finally, a partial projection of the vehicle at a future position can additionally be displayed by means of the display device, wherein the partial projection comprises at least one component group of the vehicle.

A driver of the vehicle can thus be assisted in the preparation for traveling in a bottleneck by means of the bottleneck assistance system according to the invention. The bottleneck assistance system comprises a computing unit and a display device. The computing unit can be designed here, for example, as at least one electronic control unit of the vehicle, which comprises one or more programmable processors. Moreover, the computing unit can have a computer-readable storage medium, on which a computer program is stored. The computer program can be executed on the computing unit, for example, in order to detect the bottleneck in the surroundings data. The display device can be designed, for example, as a display of an onboard computer, a navigation system, or the like. The display device can in particular also be designed as a head-up display.

Surroundings data received from the surroundings sensor of the vehicle comprise at least image data. In other words, the vehicle can thus comprise a camera as a surroundings sensor. Further surroundings sensors can be, for example, an ultrasonic sensor, a radar sensor, and/or a lidar sensor. The surroundings data can describe the surroundings of the vehicle. For example, the surroundings data can describe the surroundings by means of point clouds, occupancy grid maps, and/or by means of so-called object lists. A drivable area can thus be extracted from the surroundings data. A future distance between an object in the surroundings and the vehicle can also be determined. Such an object can represent the at least one obstacle in the surroundings. The future distance between the at least one obstacle and the vehicle or the driving tube of the vehicle can be predicted on the basis of the steering angle.

In other words, it can thus be predicted whether the at least one obstacle in the surroundings is located in the vicinity of the driving tube or is located within a predetermined distance to a driving tube of the vehicle. It can thus be predicted whether the distance will fall below the predetermined distance between the at least one obstacle and the driving tube. If the distance falls below the predetermined distance, this can indicate a future collision when driving in the bottleneck.

If a bottleneck is thus detected, the driver of the vehicle can be informed about this by means of the display device. The image data can be displayed here to the driver. It is possible here that the driving tube of the vehicle is projected in the image data. In addition, a partial projection of the vehicle can be projected in the image data. In particular, the entire vehicle can thus be projected in the image data. However, it is also conceivable that only individual component groups of the vehicle are projected in the image data. For example, only the exterior mirror and/or the vehicle front can also be projected in the image data.

In other words, an augmented reality is thus created for the driver of the vehicle by means of the display device. The driver of the vehicle can thus be assisted when traveling in the bottleneck by means of augmented reality. Among other things, the vehicle can thus be displayed in an area around the bottleneck (before traveling in the bottleneck) to the driver of the vehicle by means of the bottleneck assistance system according to the invention. The driver of the vehicle can thus directly assess how much space is available to him when traveling in the bottleneck. A collision with the at least one obstacle in the surroundings of the vehicle can thus be prevented.

It is advantageous in this case if the future position, at which the partial projection of the vehicle is displayed by means of the display device, is arranged essentially within the driving tube and in an area around the bottleneck. In other words, the future position is thus to be located within the driving tube. Steering angle and future position can thus be set in relation to one another. It can thus be ensured that the future position, at which the partial projection of the vehicle is displayed, corresponds to an actual position of the vehicle in the future. Because the future position is arranged in an area around the bottleneck, it can be ensured that the driver of the vehicle has relevant information for traveling in the bottleneck displayed.

A further embodiment of the bottleneck assistance system provides that the bottleneck assistance system is furthermore configured to display the partial projection of the vehicle displayed by means of the display device in animated form. In particular, the partial projection of the vehicle can be displayed in animated form such that traveling in the bottleneck is indicated or visualized by means of the display device. The animated display of the partial projection when traveling in the bottleneck creates a better spatial understanding of the situation. The driver can thus better assess the situation. Furthermore, possible hazards can be recognized better by the driver.

A further embodiment provides that the bottleneck assistance system is furthermore configured to output a warning message depending on the at least one obstacle and/or depending on the bottleneck by means of the display device. In the case of an imminent collision of the vehicle with the at least one obstacle, a warning message can thus be output. A warning message can also be output if, for example, the distance between the vehicle at the future position and the obstacle falls below a minimum distance. In other words, a warning message can thus be output depending on the bottleneck. Such a warning message can be, for example, in the form of an illuminated symbol (warning triangle), a colored driving tube (displayed red in the augmented reality), a (red) colored boundary of the driving tube, a highlight of at least a part of the partial projection, which is possibly involved in a potential collision. The driver can be prepared for critical situations by outputting the warning message. The attentiveness of the driver can thus be heightened.

Furthermore, it can also be advantageous if the warning message output by means of the display device comprises an optical change of the display partial projection of the vehicle. In other words, the warning message can thus be designed such that the partial projection of the vehicle and/or parts of the partial projection of the vehicle optically change. If, for example, the entire vehicle in the image data is projected as the partial projection of the vehicle and a collision is imminent of an exterior mirror of the vehicle with the at least one obstacle, which characterizes the bottleneck, the exterior mirror can be highlighted in color in the context of the partial projection of the vehicle, for example. It is also conceivable that parts of the partial projection of the vehicle flash, thus, for example, the exterior mirror projected in the image data. Additionally or alternatively, it is conceivable that a warning tone is also output.

The driver can be warned about a critical situation by the optical change of the displayed partial projection. The optical change of the displayed partial projection can enhance the awareness of the driver. Moreover, a warning message which comprises an optical change of the displayed partial projection is particularly intuitively comprehensible for the driver of the vehicle.

It can also be advantageous if the warning message output by means of the display device comprises a changed color representation of an outer boundary of the driving tube. If, for example, the at least one obstacle which characterizes the bottleneck is located on the right side of the vehicle and moreover a collision is imminent and/or a small distance is to be expected between the vehicle and the at least one obstacle, the driving tube or the driving tube boundary on the right side can thus have a changed color representation. The driving tube—if no collision is imminent—is typically projected with green color in the image data. In case of an imminent collision or a small distance, the boundary of the driving tube or also the entire driving tube can be projected red in the image data. This intuitive representation can result in an improved understanding of the situation by the driver of the vehicle.

Moreover, it can be particularly advantageous if the partial projection of the vehicle displayed by means of the display device comprises at least one exterior mirror as the at least one component group of the vehicle. In bottlenecks, it can happen or it is often the case that initially a collision of the exterior mirror of the vehicle occurs with the at least one object which characterizes the bottleneck. It is therefore advantageous if in particular the exterior mirror is projected in the image data. The driver of the vehicle thus receives an impression beforehand whether he/she will possibly scratch and/or damage the exterior mirrors of the vehicle when traveling in the bottleneck.

In this context, it can also be advantageous if the bottleneck assistance system is furthermore configured to receive a mirror position of the at least one exterior mirror and the warning message output by means of the display device takes place depending on the mirror position. For example, it is conceivable that it is possible to travel in the bottleneck with folded-in exterior mirror without collision, but it is not possible without collision with folded-out exterior mirror. Information about the current alignment or arrangement or positioning of the at least one exterior mirror of the vehicle can be provided by the reception of the mirror position. In this context, it is possible that, for example, the warning message comprises a request to fold in the mirror and/or information on the automated folding in of the mirror. The level of safety when traveling in the bottleneck can thus be improved overall. Finally, an improved impression about the situation in the bottleneck can thus be conveyed to the driver of the vehicle. Furthermore, items of information and/or messages about possible (required) adjustments of the mirror position can be offered to the driver of the vehicle while traveling in the bottleneck.

In this context, it can finally also be advantageous if the bottleneck assistance system is furthermore configured to receive a mirror position of the at least one exterior mirror and to output a suggestion for adjusting the at least one exterior mirror depending on the mirror position and/or depending on the at least one obstacle and/or depending on the bottleneck by means of the display device. As already indicated, it can thus be suggested to the driver of the vehicle that the at least one exterior mirror of the vehicle be folded in. It can thus be ensured that it is possible to travel in the bottleneck without collisions. It is particularly advantageous here if it is only possible to travel in the bottleneck when the exterior mirrors are folded in.

A method according to the invention for operating a bottleneck assistance system for a vehicle comprises receiving surroundings data from a surroundings sensor of the vehicle, wherein the surroundings data comprise at least image data and describe the surroundings of the vehicle. Furthermore, the method for operating the bottleneck assistance system comprises detecting a bottleneck in the surroundings data, wherein the bottleneck is described by at least one obstacle in the surroundings, which is located at least in some areas within a predetermined distance to a driving tube of the vehicle. Finally, the method for operating the bottleneck assistance system comprises displaying the image data together with the driving tube projected in the image data. A partial projection of the vehicle is displayed here at a future position, wherein the partial projection comprises at least one component group of the vehicle.

In addition, the present invention comprises a computing device for a vehicle, which is configured to carry out a method according to the invention and the advantageous embodiments thereof. The computing device can be designed, for example, as an electronic control unit, which comprises one or more programmable processors.

A computer-readable storage medium according to the invention comprises commands which, upon the execution by a computing device, prompt it to carry out a method according to the invention and the advantageous embodiments thereof.

A further aspect of the invention relates to a computer program, comprising commands which, upon the execution of the program by a computing device, prompt it to carry out a method according to the invention and the advantageous embodiments thereof.

The preferred embodiments presented with reference to the bottleneck assistance system according to the invention and the advantages thereof apply accordingly to the method according to the invention. Furthermore, the preferred embodiments presented with reference to the bottleneck assistance system according to the invention and the advantages thereof also apply to the computing device according to the invention, the computer program according to the invention, and the computer-readable storage medium according to the invention.

Further features of the invention result from the claims, the figures, and the description of the figures. The features and combinations of features mentioned above in the description, as well as the features and combinations of features mentioned hereinafter in the description of the figures and/or solely shown in the figures are usable not only in the respective specified combination, but also in other combinations or alone, without departing from the scope of the invention.

The invention will now be explained on the basis of preferred exemplary embodiments and with reference to the appended drawings. In the figures:

### BRIEF DESCRIPTION OF THE DRAWINGS

FIG. 1 shows a schematic representation of a vehicle, comprising a bottleneck assistance system,

FIG. 2a shows a schematic representation of a vehicle when traveling in a bottleneck, and

FIG. 2b shows a schematic representation of a display device of a bottleneck assistance system when traveling in the bottleneck according to FIG. 2a.

In the figures, identical or functionally-identical elements are provided with identical reference signs.

### DETAILED DESCRIPTION OF THE DRAWINGS

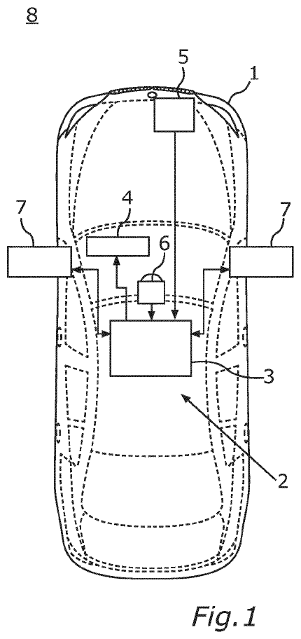

FIG. 1 shows a schematic representation of a vehicle 1, shown here as a passenger vehicle, in a top view. The vehicle 1 comprises a bottleneck assistance system 2. The bottleneck assistance system 2 in turn comprises a computing device 3, a display device 4, and a surroundings sensor 5. In addition, the bottleneck assistance system comprises a camera 6 as an additional surroundings sensor. Moreover, the exterior mirrors 7 are schematically shown in FIG. 1.

The computing device 3 can receive surroundings data from the surroundings sensor 5. The surroundings data of the surroundings sensor 5 of the vehicle 1 in turn comprise image data of the camera 6. The surroundings data can describe the surroundings 8 of the vehicle 1. A bottleneck 9 can be detected in the surroundings data of the surroundings sensor 5 or the camera 6 by means of the computing device. The image data of the camera 6 can be displayed by means of the display device 4. In addition, a driving tube 10 can be projected in the image data. In other words, an image of the camera 6 can thus be displayed by means of the display device 4, wherein in addition the driving tube 10 can be projected in the image of the camera 6.

A mirror position, thus an alignment of the exterior mirrors 7, can influence the driving tube 10 here. For example, the driving tube 10 can be narrower if the exterior mirrors 7 are folded in. The computing device 3 can receive the mirror position of the exterior mirrors 7. The correct driving tube 10 can thus always be determined.

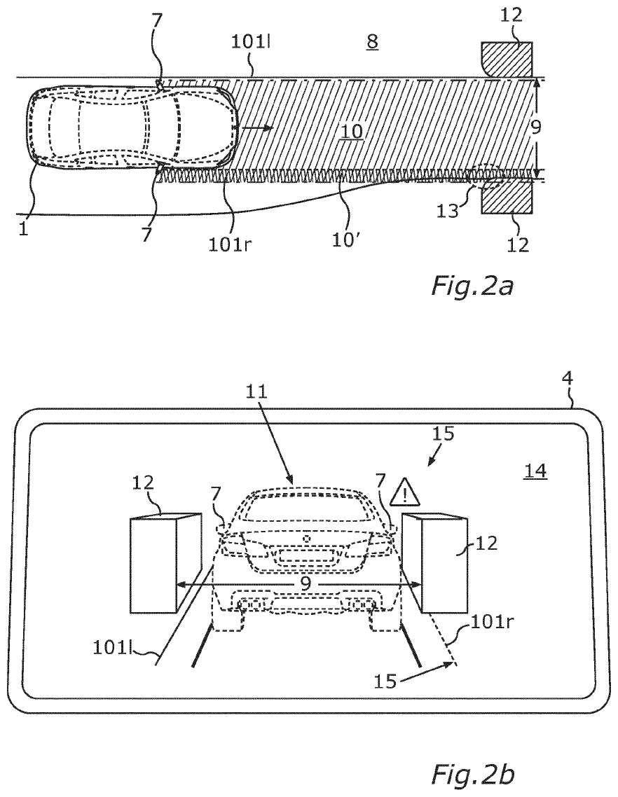

In addition, a partial projection 11 of the vehicle 1 can be projected in the image by means of the display device 4. The partial projection 11 can be, for example, a single component group of the vehicle 1. Thus, for example, only the exterior mirrors 7 can be displayed as the partial projection 11 of the vehicle 1 in the image data. However, it is also possible that the entire vehicle 1 is projected as the partial projection 11 in the image data (cf. FIG. 2b).

FIG. 2a shows a schematic representation of the vehicle 1 when traveling in the bottleneck 9. The bottleneck 9 can be characterized by at least one obstacle 12 in the surroundings 8 of the vehicle 1. The at least one obstacle 12 can include, for example, guide rails, trees, rocks, roadway boundary walls (as shown in FIG. 2a), or the like. In FIG. 2a, the driving tube 10 is simply shown shaded. The driving tube 10 comprises the two exterior mirrors 7 of the vehicle 1 here. It can be seen in the area 13 that a collision of the vehicle 1 with the at least one obstacle 12 is imminent. The driving tube 10 can be reduced in its width by folding in the right exterior mirror 7. This is represented in FIG. 2a by the omission of the densely shaded area 10′. It is thus possible that the vehicle 1 can pass the bottleneck 9.

The boundaries of the driving tube 10 are identified by the dashed lines 1011 and 101r in FIG. 2a.

FIG. 2b shows a schematic representation of the display device 4, wherein the image data of the camera 6 are displayed by means of the display device 4. In addition, the driving tube 10 of the vehicle 1 can be projected in the image data 14. It is also conceivable that only the boundaries 1011 and 101r of the driving tube 10 are projected in the image data 14 (as shown in FIG. 2b). Furthermore, a partial projection 11 of the vehicle 1 can additionally be displayed at a future position, in particular at the bottleneck 9, in the image data 14.

FIG. 2b schematically shows the traffic situation from FIG. 2a here. The bottleneck assistance system 2 can be configured to output a warning message 15 by means of the display device 4. The warning message 15 can be, for example, an optical change of the displayed partial projection 11 of the vehicle 1. The optical change is shown in FIG. 2b by the warning triangle. Furthermore, the warning message 15 output by means of the display device 4 can comprise a changed color representation of the outer boundary of the driving tube 10. In FIG. 2b, a changed color representation of the outer boundary 101r of the driving tube 10 is indicated by a dashed line in contrast to the outer boundary 1011 of the driving tube 10.

Although the schematic representation of the display device 4 suggests a static situation in FIG. 2b, in general the bottleneck assistance system 2 can be configured to display the partial projection 11 of the vehicle 1 displayed by means of the display device 4 in an animated manner. In this context, it is conceivable in particular that the partial projection 11 is displayed animated in such a way that the impression results for the driver of the vehicle 1 that the partial projection 11 of the vehicle 1 is traveling in the bottleneck 9.

1.-10. (canceled)

11. A bottleneck assistance system for a vehicle comprising:
a computing device configure to: i) receive surroundings data from a surroundings sensor of the vehicle, which surroundings data comprises at least image data and describe the surroundings of the vehicle, ii) detect a bottleneck in the surroundings data, wherein the bottleneck is described by at least one obstacle in the surroundings, which is located at least in some areas within a predetermined distance to a driving tub of the vehicle, and iii) display the image data together with the driving tube projected in the image data via a display device, wherein
in addition a partial projection of the vehicle at a future position is displayed via the display device, and the partial projection comprises at least one component group of the vehicle.

12. The bottleneck assistance system according to claim 11, wherein the future position at which the partial projection of the vehicle is displayed via the display device is arranged essentially within the driving tube and in an area around the bottleneck.

13. The bottleneck assistance system according to claim 12, wherein the bottleneck assistance system is further configured to display the partial projection of the vehicle displayed by means of the display device in an animated manner.

14. The bottleneck assistance system according to claim 11, wherein the bottleneck assistance system is further configured to output a warning message depending on the at least one obstacle and/or depending on the bottleneck via the display device.

15. The bottleneck assistance system according to claim 14, wherein the warning message output by means of the display device comprises an optical change of the displayed partial projection of the vehicle.

16. The bottleneck assistance system according to claim 14, wherein the warning message output via the display device comprises a changed color representation of an outer boundary of the driving tube.

17. The bottleneck assistance system according to claim 15, wherein the warning message output via the display device comprises a changed color representation of an outer boundary of the driving tube.

18. The bottleneck assistance system according to claim 11, wherein the partial projection of the vehicle displayed via the display device comprises at least one exterior mirror as the at least one component group of the vehicle.

19. The bottleneck assistance system according to claim 18, wherein the bottleneck assistance system is further configured to receive a mirror position of the at least one exterior mirror and the warning message output via the display device takes place depending on the mirror position.

20. The bottleneck assistance system according to claim 18, wherein the bottleneck assistance system is further configured to receive a mirror position of the at least one exterior mirror and, via the display device, to output a suggestion to adjust the at least one exterior mirror depending on the mirror position and/or depending on the at least one obstacle and/or depending on the bottleneck.

21. The bottleneck assistance system according to claim 19, wherein the bottleneck assistance system is further configured to receive a mirror position of the at least one exterior mirror and, via the display device, to output a suggestion to adjust the at least one exterior mirror depending on the mirror position and/or depending on the at least one obstacle and/or depending on the bottleneck.

22. A method for operating a bottleneck assistance system for a vehicle, comprising:
receiving surroundings data from a surroundings sensor of the vehicle, wherein the surroundings data at least comprises image data and describes the surroundings of the vehicle,
detecting a bottleneck in the surroundings data, wherein the bottleneck is described by at least one obstacle in the surroundings, which is located at least in some areas within a predetermined distance to a driving tube of the vehicle, and
displaying the image data together with the driving tube projected in the image data, wherein
a partial projection of the vehicle at a future position is displayed, wherein the partial projection comprises at least one component group of the vehicle.
